(19) United States
(12) Patent Application Publication
(10) Pub. No.: US 2015/0198448 A1
(43) Pub. Date: Jul. 16, 2015

(54) INFORMATION NOTIFICATION SYSTEM, TRANSMITTING DEVICE, AND RECEIVING DEVICE

(71) Applicants: DENSO CORPORATION, Kariya-city (JP); NIPPON SOKEN, INC., Nishio-city (JP)

(72) Inventors: Norio SANMA, Okazaki-city (JP); Sei IGUCHI, Okazaki-city (JP)

(21) Appl. No.: 14/580,959

(22) Filed: Dec. 23, 2014

(30) Foreign Application Priority Data
Jan. 14, 2014 (JP) 2014-4265

(51) Int. Cl. G01C 21/26; G01C 21/34

(52) U.S. Cl. CPC G01C 21/26; G01C 21/34

(57) ABSTRACT

An information notification system includes a transmitting device, a receiving device, a driver related information acquirement section, and a parameter setting section. The transmitting device includes an assist information acquirement section acquiring assist information that assists a driver during driving of a vehicle. The receiving device includes a notification section notifying the driver of the assist information in a tactile manner. The driver related information acquirement section acquires driver related information, which is associated with a perceivability of the driver to the assist information. The parameter setting section sets notification parameter based on the driver related information. The notification section notifies of the assist information to the driver corresponding to the notification parameter.

### CROSS REFERENCE TO RELATED APPLICATION

This application is based on Japanese Patent Application No. 2014-004265 filed on Jan. 14, 2014, the disclosure of which is incorporated herein by reference.

### TECHNICAL FIELD

The present disclosure relates to an information notification system that notifies information to a driver of a vehicle in a tactile manner, and a transmitting device and a receiving device utilized in the information notification system.

### BACKGROUND

Information notification systems have been proposed for notifying a user of drive assist information, such as danger information, to a driver of a vehicle in a tactile manner, for example, by a vibration stimulus. In this kind of information notification system, a study has been carried out for improving a perception of the tactile information by the user. For example, JP 2007-193453 A discloses a device that transfers a vibration, which generates a stochastic resonance, to a hand of the driver while the driver grips a steering wheel of the vehicle with the hand.

In the device disclosed in JP 2007-193453 A, the vibration transferred to the hand of the driver generates stochastic resonance in order to improve the perception of vibration by the user. Thus, with the device disclosed in JP 2007-193453 A, a driver who has a difficulty in sensing a tactile stimulus caused by an old age or other reasons is also able to properly sense the notification of the information.

However, sometimes the vibration that generates the stochastic resonance may give an excessive stimulus to a driver, and some divers may feel uncomfortable to the excessive stimulus.

### SUMMARY

In view of the foregoing difficulties, it is an object of the present disclosure to provide an information notification system, and a transmitting device and a receiving device utilized in the information notification system, in order to properly notify information to a driver in a tactile manner with an improved suitability to the driver.

According to a first aspect of the present disclosure, an information notification system includes a transmitting device, a receiving device, a driver related information acquirement section, and a parameter setting section. The transmitting device includes an assist information acquirement section acquiring assist information that assists a driver during a driving of a vehicle. The receiving device includes a notification section notifying the driver of the assist information in a tactile manner. The driver related information acquirement section acquires driver related information. The driver related information is associated with a perceivability of the driver to the assist information that is notified to the driver in the tactile manner. The parameter setting section sets a notification parameter based on the driver related information acquired by the driver related information acquirement section. The notification section notifies the driver of the assist information corresponding to the notification parameter set by the parameter setting section.

With the above information notification system, information can be notified to the driver in a tactile manner with an improved suitability to the driver.

According to a second aspect of the present disclosure, a transmitting device, which performs a communication with a receiving device, includes an assist information acquirement section and a driver related information acquirement section. The assist information acquirement section acquires assist information that assists a driver during a driving of a vehicle. The driver is notified of the assist information in a tactile manner. The driver related information acquirement section acquires driver related information. The driver related information is associated with a perceivability of the driver to the assist information notified to the driver in the tactile manner. The transmitting device transmits the assist information and the driver related information to the receiving device.

With the above transmitting device, since the transmitting device acquires and transmits the assist information and the driver related information to the receiving device, information can be notified to the driver in a tactile manner with an improved suitability to the driver.

According to a third aspect of the present disclosure, a receiving device, which performs a communication with a transmitting device, includes a notification section and a parameter setting section. The transmitting device transmits assist information and driver related information to the receiving device. The assist information assists a driver during a driving of a vehicle and the driver related information is associated with a perceivability of the driver to the assist information. The notification section notifies the driver of the assist information in a tactile manner. The parameter setting section sets a notification parameter based on the driver related information. The notification section notifies the driver of the assist information corresponding to the notification parameter set by the parameter setting section.

With the above receiving device, the information is notified to the driver according to the driver related information. Thus, the information can be notified to the driver in a tactile manner with an improved suitability to the driver.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing a configuration of an information notification system which the present disclosure is applied to;

FIG. 2 is a diagram showing an arrangement of vibrators included in the information notification system;

FIG. 3 is a diagram showing a configuration of a vehicular system including the information notification system;

FIG. 4 is a diagram showing a configuration of a tactile information output device included in the vehicular system;

FIG. 5 is a block diagram showing a configuration of a mobile terminal utilized in the information notification system;

FIG. 6A to 6C are diagrams showing display window example of the mobile terminal;

FIG. 7 is a flowchart showing a process executed by the mobile terminal;

FIG. 8A and FIG. 8B are diagrams showing parameter tables used for setting parameters for the tactile notification;

FIG. 9A is a diagram showing a case that requires a tactile notification, FIG. 9B is a diagram showing vibrators that are divided into multiple groups for performing apparent motion, and FIG. 9C is a diagram showing a vibration order of each group of the vibrators;

FIG. 10A is a diagram showing a different case that requires a tactile notification, FIG. 10B is a diagram showing vibrators that are divided into multiple groups for performing a high speed vibration, and FIG. 10C is a diagram showing a vibration order of each group of the vibrators;

FIG. 11 is a diagram showing an actuator that generates tactile information according to another embodiment of the present disclosure; and

FIG. 12 is a diagram showing an actuator that generates tactile information according to another embodiment of the present disclosure.

### DETAILED DESCRIPTION

The following will describe embodiments of the present disclosure with reference to the drawings.

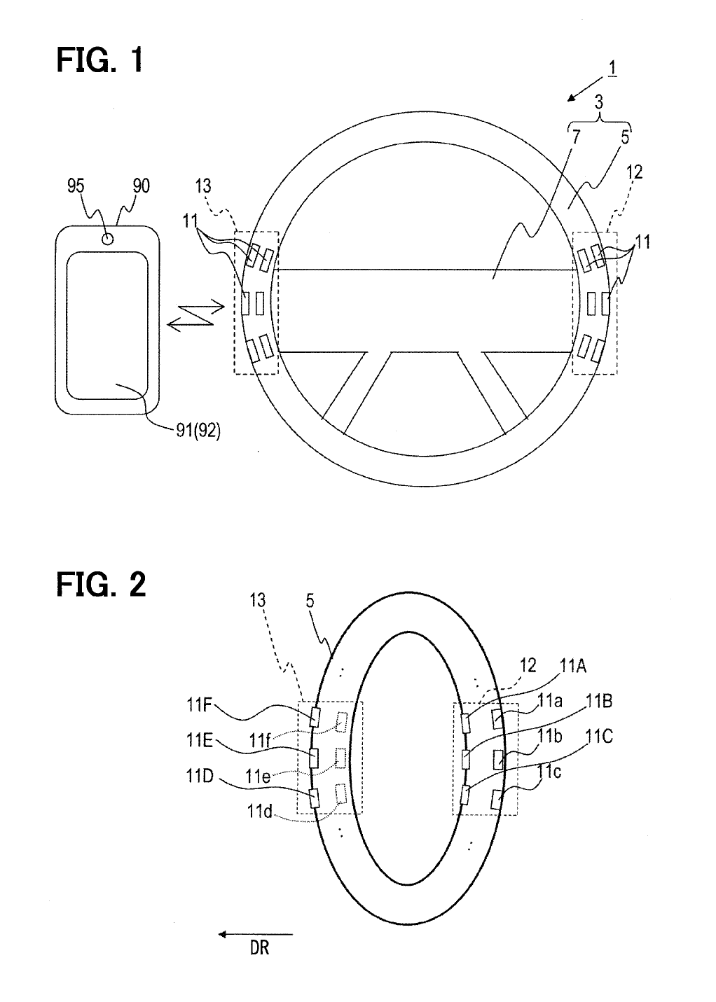

As shown in FIG. 1, an information notification system 1 according to the present disclosure includes a steering wheel 3 and a mobile terminal 90. In the present embodiment, the steering wheel 3 is equipped to a vehicle, and the mobile terminal 90 is provided by a multiple function mobile phone, such as a smart phone. In the present disclosure, suppose that the mobile terminal 90 is carried into the vehicle by a driver of the vehicle.

The steering wheel 3 includes a wheel portion 5 having a circular shape and a spoke portion 7 that supports the wheel portion 5. The steering wheel 3 further includes a tactile information output device 10 attached thereto. As shown in FIG. 1, the wheel portion 5 includes multiple vibrators 11 arranged on a surface of the wheel portion 5. Specifically, six vibrators 11 may be arranged on each of the left side and right side of the wheel portion 5, which is to be gripped by the driver using a hand. Each vibrator 11 may include a compact motor for generating a vibration.

As shown in FIG. 2, three vibrators 11A, 11B, 11C may be arranged on a front right side of the wheel portion 5, three vibrators 11D, 11E, 11F may be arranged on a front left side of the wheel portion, three vibrators 11a, 11b, 11c may be arranged on a back right side of the wheel portion 5, and three vibrators 11d, 11e, 11f may be arranged on a back left side of the wheel portion 5. Herein, front side of the wheel portion 5 is a side of the wheel portion 5 which faces to the driver (DR) of the vehicle, the back side of the wheel portion 5 is a side of the wheel portion 5 which faces to an instrument panel of the vehicle, and the left and right side are defined from a view of the driver.

As shown in FIG. 2, the vibrators 11A, 11B, 11C, 11D, 11E, 11F are arranged on the front side of the wheel portion 5 in a clockwise direction. The vibrators 11a, 11b, 11c, 11d, 11e, 11f are arranged on the back side of the wheel portion 5 in a clockwise direction. The vibrators 11A, 11B, 11C, 11a, 11b, 11c arranged on the right side of the wheel portion 5 function as a first actuator 12, and generate tactile information. The vibrators 11D, 11E, 11F, 11d, 11e, 11f arranged on the left side of the wheel portion 5 function as a second actuator 13, and generate tactile information.

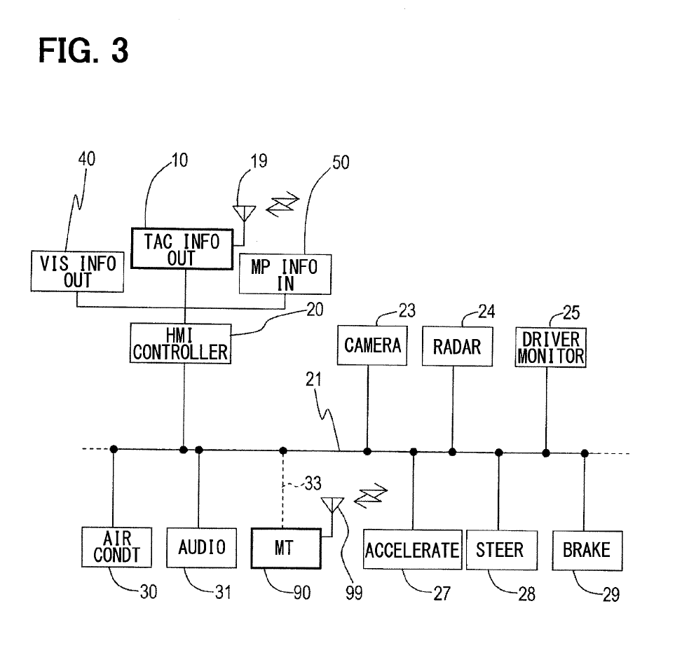

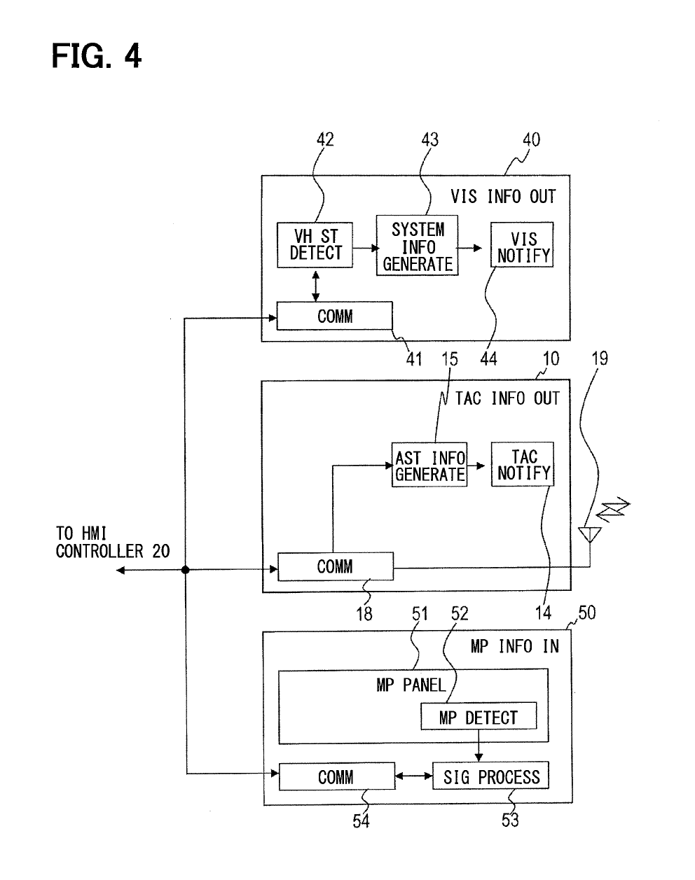

FIG. 4 is a diagram showing a configuration of the tactile information output device (TACT INFO OUT) 10. As shown in FIG. 4, the tactile information output device 10 includes a tactile notification section (TAC NOTIFY) 14, an assist information generation section (AST INFO GENERATE) 15 and a communication section (COMM) 18. The tactile notification section 14 controls the vibrators 11 to notify the user of the information in a tactile manner. As shown in FIG. 3 and FIG. 4, the communication section 18 performs a data communication with the mobile terminal 90 via an antenna 19, and performs a data communication with an in-vehicle local area network (LAN) 21 via a human machine interface (HMI) controller 20. The assist information generation section 15 transmits instructions including notification parameters to the tactile notification section 14 so that the tactile notification section 14 controls the vibrators 11 to vibrate based on the predetermined notification parameter.

As shown in FIG. 3, the in-vehicle LAN 21 connects various cameras 23 equipped to the vehicle, various monitoring devices including radar 24 that monitors periphery area of the vehicle, and inside monitors equipped in a compartment of the vehicle for monitoring the driver. The inside monitors may include a driver monitor 25 that detects and warns a drowsy state of the driver. The in-vehicle LAN 21 may further connect travelling related devices including an accelerator pedal sensor (ACCELERATE) 27, a steering sensor (STEER) 28, a brake pedal sensor (BRAKE) 29 and devices for comfort and convenience including an air conditioner (AIR CONDT) 30 and audio device (AUDIO) 31. The mobile terminal (MT) 90 may be connected to the in-vehicle LAN 21 by a wire connection based on a controller area network (CAN) 33. In the present embodiment, suppose that the mobile terminal 90 performs the communication under a universal serial bus (USB) protocol. In this case, since the communication protocol of the mobile terminal 90 is different from the communication protocol of the CAN 33, a converter may be disposed between the CAN 33 and the mobile terminal 90 to enable the communication between the CAN 33 and the mobile terminal 90. The HMI controller 20 is connected with the tactile information output device 10, a visual information output device (VIS INFO OUT) 40, and a manipulation information input device (MP INFO IN) 50.

As shown in FIG. 3, the visual information output device 40 includes a communication section (COMM) 41, a vehicle state detection section (VH ST DETECT) 42 connected with the communication section 41, a system information generation section (SYSTEM INFO GENERATE) 43 connected with the vehicle state detection section 42, and a visual notification section (VIS NOTIFY) 44 connected with the system information generation section 43. The communication section 41 performs a communication with the in-vehicle LAN 21 via the HMI controller 20. The vehicle state detection section 42 detects a vehicle state via the communication section 41, the system information generation section 43 generates information related to the vehicle state, and the visual notification section 44 notifies the driver of visual information on a display screen, for example, a head-up display.

The manipulation information input device 50 includes a manipulation panel (MP PANEL) 51, a manipulation detection section (MP DETECT) 52, a signal processing section (SIG PROCESS) 53, and a communication section (COMM) 54. The manipulation detection section 52 detects a manipulation made by the driver. For example, the manipulation may include a manipulation of a lever on the manipulation panel 51. The signal processing section 53 generates a signal related to the manipulation detected by the manipulation detection section 52, and the communication section 54 transmits the signal generated by the signal processing section 53 to the HMI controller 20.

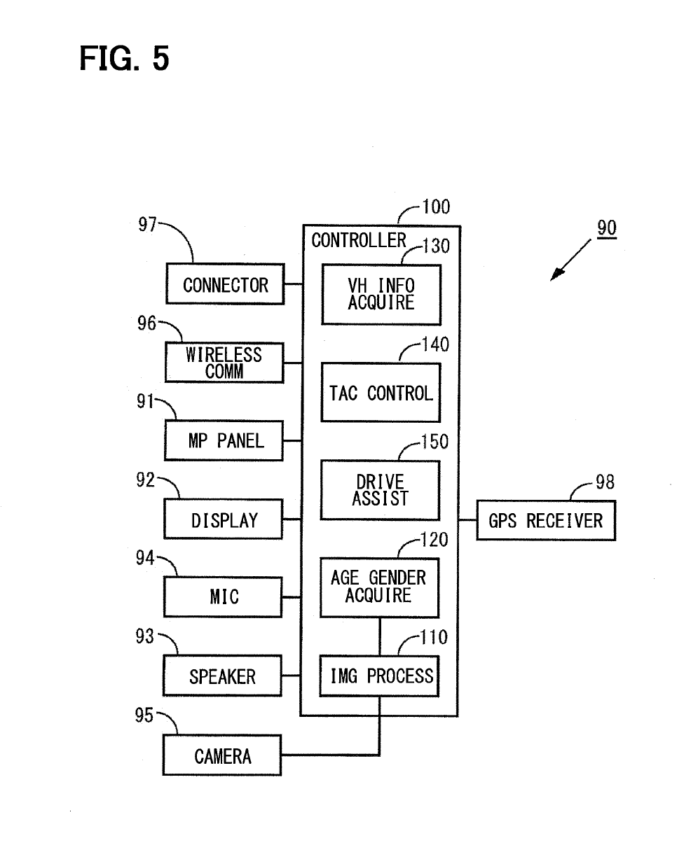

As shown in FIG. 5, similar to a general purpose multiple function mobile phone, the mobile terminal 90 includes a controller 100, a manipulation panel (MP PANEL) 91, a display screen (DISPLAY) 92, a speaker 93, a microphone (MIC) 94, a camera 95, a wireless communication module (WIRELESS COMM) 96, a connector 97, a global positioning system (GPS) receiver 98, or the like. The speaker 93 and the microphone 94 are well-known components for making a voice call. As shown in FIG. 1, the manipulation panel 91 may be provided by a touch panel disposed on a surface of the display screen 92. The display screen 92 may be provided by a liquid crystal display panel. As shown in FIG. 5, the camera 95 is a well-known component for taking images of a face of the driver.

The wireless communication module 96 performs a wireless communication via an antenna 99 with a telephone line or an internet. The wireless communication module 96 is also capable of performing a wireless communication based on a Bluetooth (registered trademark) or is capable of performing a vehicle-to-vehicle communication or a vehicle-to-roadside communication. The tactile information output device 10 may perform a communication with the mobile terminal 90 based on the Bluetooth. The connector 97 is able to connect with the CAN 33, and enables a communication based on CAN. The GPS receiver 98 receives signals transmitted from a GPS satellite, and detects a position of the mobile terminal 90. Herein, the position of the mobile terminal 90 includes latitude and longitude.

Each of the manipulation panel 91, the display screen 92, the speaker 93, the microphone 94, the camera 95, the wireless communication module 96, the connector 97, and the GPS receiver 98 is connected with the controller 100 of the mobile terminal 90. The controller 100 is provided by a well-known microcomputer, and includes a central processing unit (CPU), a read only memory (ROM), a random access memory (RAM) or the like. The configuration of the controller 100 is not shown in the drawing in detail. The controller 100 includes processing units similar to processing units of multiple function mobile phones. In addition, the controller 100 according to the present embodiment further includes an image processing unit (IMG PROCESS) 110, an age gender acquirement unit (AGE GENDER ACQUIRE) 120, a vehicle information acquirement unit (VH INFO ACQUIRE) 130, a tactile control unit (TAC CONTROL) 140, and a drive assist processing unit (DRIVE ASSIST) 150. Each function of the image processing unit 110, the age gender acquirement unit 120, the vehicle state acquirement unit 130, the tactile control unit 140, and the drive assist processing unit 150 may be provided by a software program.

When the camera 95 takes an image of the face of the driver, the image processing unit 110 performs a processing to the image, and the age gender acquirement unit 120 acquires an age and a gender of the driver based on the processed image. The camera 95 may take an image of a driving license of the driver. In this case, the age gender acquirement unit 120 may acquire the age and the gender of the driver from descriptive information written on the image of the driving license of the driver.

The vehicle information acquirement unit 130 acquires an ON or OFF state of the audio device 31 or the like as the vehicle information via the in-vehicle LAN 21. Although not shown in FIG. 3, a passenger sensor that senses a passenger seated on a seat of the vehicle may be connected with the in-vehicle LAN 21. In this case, the vehicle information acquirement unit 130 may acquire the number of the passengers in the vehicle as the vehicle information. The tactile control unit 140 controls the tactile information output device 10. The drive assist processing unit 150 executes a drive assist application, which will be described below.

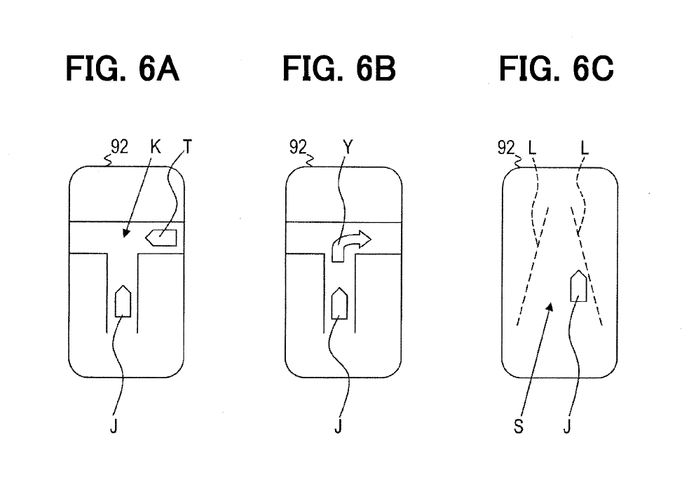

The following will describe a display example on the display screen 92 when the controller 100 executes a control process with reference to FIG. 6. Specifically, the controller 100 executes the control process related to the drive assist application in order to function as the drive assist processing unit 150. Since the drive assist application is a well-known art in this field, detailed description of the drive assist application will be omitted.

FIG. 6A shows an exemplary display window that displays a position relationship between a subject vehicle J and a different vehicle T as collision danger information when both the subject vehicle 3 and the different vehicle T travel toward a blind intersection K. Herein, the blind intersection K is an intersection where obstructions prohibit a clear front vision of crossed roads. In the exemplary display window shown in FIG. 6A, both the subject vehicle J and the different vehicle T travel toward the T-shaped blind intersection K. The display window shown in FIG. 6A is generated based on external information acquired from devices placed external side of the subject vehicle J via the vehicle-to-roadside communication or via the vehicle-to-vehicle communication. The display window shown in FIG. 6A is generated by a software application, such as a front cross traffic alert. The application may further include pedestrians in addition to the different vehicle T in the display window.

FIG. 6B shows an exemplary display window that displays guidance route information for guiding the subject vehicle J to a preliminarily set destination along a suggested route. In this display window, the guidance route information is indicated by an arrow Y. The display window shown in FIG. 6B is generated by a software application, such as a navigation application. The application may further include estimated arrival time or traffic congestion information in the display window.

FIG. 6C shows an exemplary display window that displays lane deviation information. The lane deviation information indicates a deviation of the subject vehicle 3 from the currently travelling traffic lane S or a possibility of the lane deviation. Specifically, the lane deviation information indicates a possibility of deviation of the subject vehicle 3 out of boundary lines L that define a width of the traffic lane S. The boundary lines L may be provided by the colored lines painted on the road for defining the traffic lanes. A center line on the road may be used as the boundary line L. The display window shown in FIG. 6C is generated by a software application, such as a lane deviation alert. In this kind of software application, when the subject vehicle 3 travels out of the boundary line L, that is, the subject vehicle 3 deviates from the currently travelling lane S, the subject vehicle J on the display window may be highlighted.

The display screen 92 of the mobile terminal 90 has a size smaller than the display screen equipped inside of the vehicle. Thus, during a driving of the vehicle, the controller 100 may transmit data indicating a situation shown in above-described exemplary display window to the visual information output device 40 via the in-vehicle LAN 21. With this configuration, enlarged images can be displayed on the display screen equipped inside of the vehicle. The display screen equipped inside of the vehicle may include the head-up display or a display screen of the navigation device. When the controller 100 executes the above-described applications, the controller 100 may transmit data to the tactile information output device 10 as needed for notifying the driver of the information in a tactile manner. In this case, the controller 100 performs the following control process with consideration of a perceivability of the driver to the tactile information. In the present embodiment, the tactile information output device 10 controls the vibrators 11 to transfer the tactile stimulus, such as vibration, to the hand of the driver.

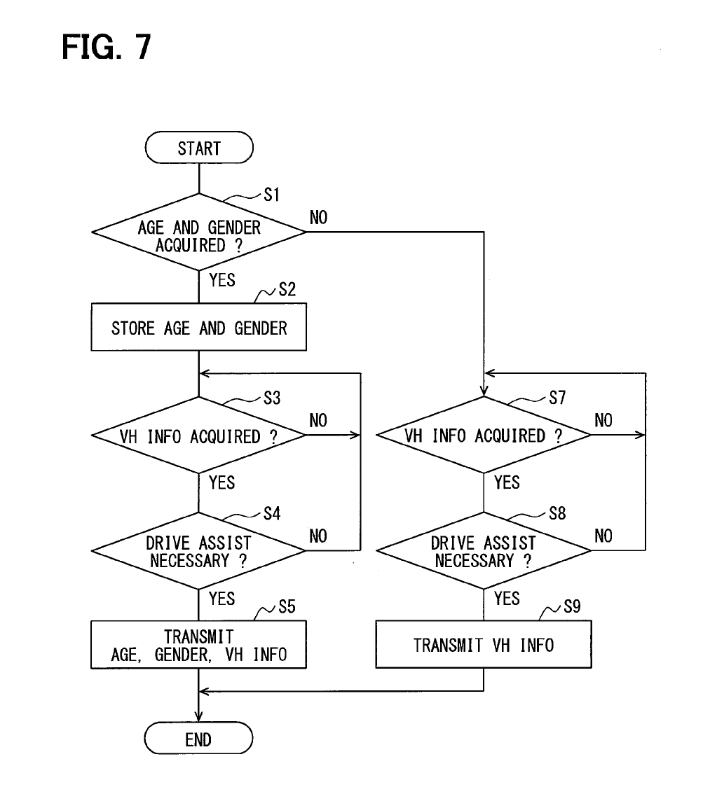

FIG. 7 shows a process executed by the controller 100 to the tactile information output device 10. The controller 100 executes the process shown in FIG. 7 in order to function as the tactile control unit 140. During a tactile notification mode is in an activated state, the CPU of the controller 100 executes the process shown in FIG. 7 at predetermined intervals based on a program stored in the ROM of the controller 100. When the tactile notification mode is activated, the vibrators 11 notify information to the driver in a tactile manner.

As shown in FIG. 7, when the process starts, the controller 100 determines whether the age and gender of the driver have been acquired by the driver information acquirement unit 120 at S1. When the age and gender have been acquired (S1: YES), the controller 100 stores the age and gender of the driver at S2. Then, the controller 100 determines whether the vehicle information has been acquired by the vehicle information acquirement unit 130 at S3. In this process, the vehicle information is information that may affect a perceivability or a sensibility of the driver to the tactile information. Since the ON or OFF state of the audio device 31 may affect the perceivability of the driver to the tactile information during the driving, the ON or OFF state of the audio device 31 will be used as the vehicle information as an example in the following description.

When the vehicle information has not been acquired (S3: NO), the controller 100 repeatedly performs the determination at S3. When the vehicle information is acquired (S3: YES), the process proceeds to S4. At S4, the controller 100 determines whether drive assist is necessary or not. For example, the controller 100 determines whether a collision possibility shown in the display window of FIG. 6A needs to be notified to the driver or not. For another example, the controller 100 may determine whether a turning right at the next intersection needs to be notified to the driver or not as shown in the display window of FIG. 6B. FIG. 6B shows the route guidance of turning right. The route guidance may also guide a turning left at the intersection.

When the controller 100 determines that the drive assist is not necessary (S4: NO), the process returns to S3, and S3 and S4 are repeatedly executed until the controller 100 determines that the drive assist is necessary (S4: YES). When the controller 100 determines that the drive assist is necessary (S4: YES), the process proceeds to S5. At S5, the controller 100 transmits, to the tactile information output device 10, the age and the gender acquired by the driver information acquirement unit 120 at S2 and the vehicle information acquired by the vehicle information acquirement unit 130 via the antenna 99, and ends the process. Hereinafter, the age and gender of the driver is referred to as driver information.

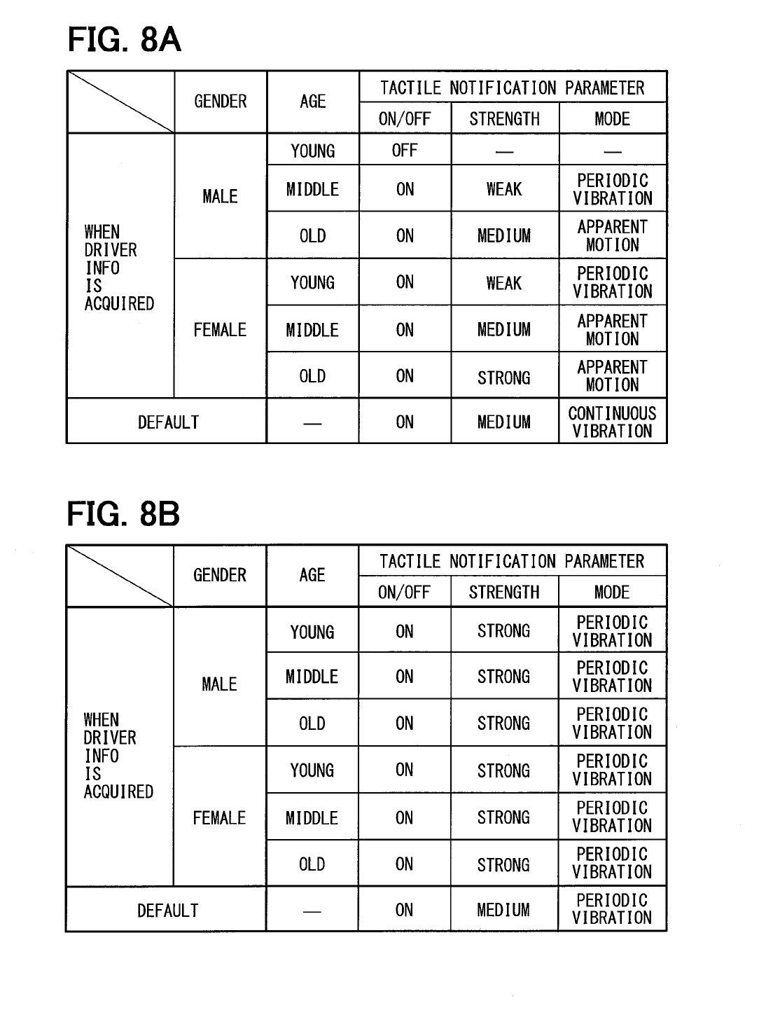

As shown in FIG. 3 and FIG. 4, when the driver information and the vehicle information are transmitted to the tactile information output device 10 via the antenna 99, the communication section 18 of the tactile information output device 10 receives the driver information and the vehicle information via the antenna 19. In the present embodiment, the assist information generation section 15 has tables shown in FIG. 8A and FIG. 8B that define tactile notification parameters based on the vehicle information and the driver information. The assist information generation section 15, based on the driver information and the vehicle information received by the communication section 18, generates and transmits instructions related to tactile notification parameters to the tactile notification section 14. Herein, the notification parameters include vibration strength and vibration mode of the vibrators 11.

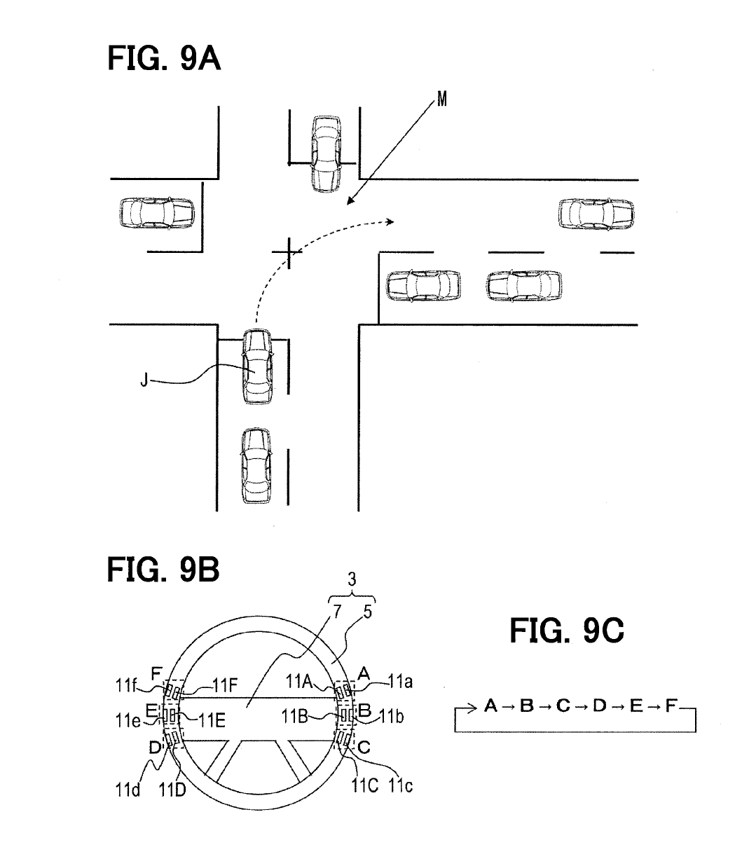

The assist information generation section 15 generates the instructions related to the vibration strength and vibration mode of the vibrators 11 corresponding to the age and gender of the driver and the ON or OFF state of the audio device 31. The vibration strength has three predetermined levels including weak, medium, and strong. Herein, the vibrators 11 are driven by the tactile notification section 14 based on the instructions transmitted from the assist information generation section 15. When the audio device 31 is in the OFF state, the assist information generation section 15 generates the instructions based on the table shown in FIG. 8A. When the audio device 31 is in the ON state, the assist information generation section 15 generates the instructions based on the table shown in FIG. 8B. When drive assist information needs to be notified to the driver, the tables shown in FIG. 8A and FIG. 8B are used for instructing the vibrations 11 to generate a corresponding vibration. Suppose a case in which the drive assist information is the route guidance which instructs the subject vehicle 3 to turn right or turn left at an intersection M when the subject vehicle J enters the intersection M as shown in FIG. 9A.

In each of FIG. 8A and FIG. 8B, ON or OFF state of tactile notification, the vibration strength of the tactile notification, and the vibration mode of the tactile notification are set corresponding to the age and gender of the driver and the ON or OFF state of the audio device 31. Herein, when the tactile notification is set to ON state, the vibrators 11 are vibrated in order to give the tactile stimulus to the driver. The assist information generation section 15 reads out the ON or OFF state, the strength, and the mode of the tactile notification from the table shown in FIG. 8A or from FIG. 8B corresponding to the driver information and the vehicle information received by the communication section 18. Then, the assist information generation section 15 transmits the information read out from the table to the tactile notification section 14.

In each table, the ON or OFF state, the strength, and the mode of the tactile notification are set for a default state with consideration of a case in which the age and gender of the driver cannot be acquired (S7: YES and S8: YES in FIG. 7). In each table, the strength indicates strength of the vibration generated by the vibrators 11. In each table, the mode includes a periodic vibration, a continuous vibration, and an apparent motion. In the periodic vibration mode, each vibrator 11 vibrates at a predetermined interval. In the continuous vibration mode, each vibrator 11 vibrates continuously. In the apparent motion mode, the vibrators 11 vibrate in order to generate an apparent motion.

The following will describe an example in which the mode of the tactile notification is set to the apparent motion with reference to FIG. 9A to FIG. 9C. In this example, the vibrators 11 are grouped into six groups A, B, C, D, E, and F as shown in FIG. 9B. The group A includes the vibrators 11A and 11a. The group B includes the vibrators 11B and 11b. The group C includes the vibrators 11C and 11c. The group D includes the vibrators 11D and 11d. The group E includes the vibrators 11E and 11e. The group F includes the vibrators 11F and 11f. When the drive assist information is the route guidance information which instructs the subject vehicle 3 to turn right at the intersection M when the subject vehicle 3 enters the intersection M as shown in FIG. 9A, the groups A to E of the vibrators 11 sequentially vibrate in an order of A, B, C, D, E, and F, and groups A to E repeat the vibration again from group A as shown in FIG. 9C. With this vibration of the vibrators 11, the driver may perceive a rotation of the wheel portion 5 of the steering wheel 3 in the clockwise direction in the hand. That is, the vibrators 11 instruct the driver to rotate the steering wheel 3 in the clockwise direction by generating the apparent motion as described above.

In FIG. 7, when the controller 100 determines that the age and gender have not been acquired (S1: NO), the process proceeds to S7. At S7, the controller 100 determines whether the vehicle information has been acquired by the vehicle information acquirement unit 130. When the vehicle information has not been acquired (S7: NO), the determination at S7 is repeatedly executed. When the vehicle information is acquired (S7: YES), the process proceeds to S8. At S8, the controller 100 determines whether the drive assist is necessary or not. When the controller 100 determines that the drive assist is not necessary (S8: NO), the process returns to S7, and S7 and S8 are repeatedly executed until the controller 100 determines that the drive assist is necessary (S8: YES). At S9, the vehicle information acquired by the vehicle information acquirement unit 130 is transmitted to the tactile information output device 10 via the antenna 99, and the controller 100 ends the process. In this case, the assist information generation section 15 generates instructions related to the strength and mode of the tactile notification based on the default state in the table shown in FIG. 8A or FIG. 8B, and transmits the instructions related to the strength and mode of the tactile notification to the tactile notification section 14.

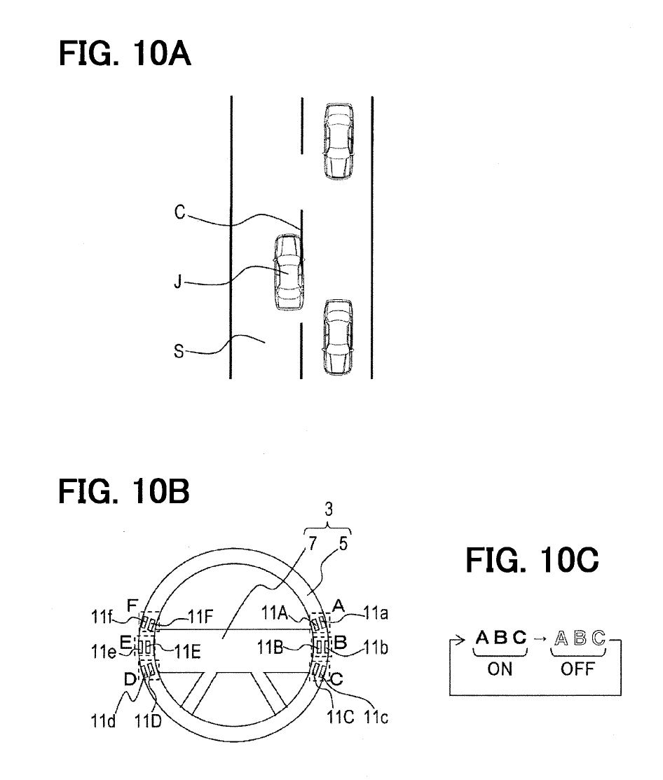

Suppose that the drive assist information is a travelling state of the subject vehicle J and the subject vehicle J has been deviated from a longitudinal center portion of the currently travelling traffic lane S and travels extremely close to a center line C of the road as shown in FIG. 10A. In this case, the vibrators 11 are vibrated in a high speed vibration mode. Specifically, the groups A, B, C of the vibrators 11 are vibrated at a high speed at the same time for a predetermined duration as an ON state, and then the high speed vibration of the groups A, B, C are stopped for the same duration as an OFF state as shown in FIG. 10C in order to perform the tactile notification to the driver. The ON state and the OFF state of the vibration are alternatively switched. Under this tactile notification, the driver may be notified of a danger on a side at which the vibrated vibrators 11 are positioned. In the case shown in FIG. 10A to 10C, the driver is notified of the danger on the right side of the vehicle. In this case, the high speed vibration is performed instead of the apparent motion, and the vibration strength and the vibration period of the tactile notification may be set corresponding to an urgency or a priority of the information to be notified to the driver. Thus, a table (not shown) slightly different from the table shown in FIG. 8A or FIG. 8B can be used in the case shown in FIG. 10A to FIG. 10C. Also in this case, the vibration strength and the vibration period are set corresponding to the age and gender of the driver.

It is noted that a flowchart or the processing of the flowchart in the present disclosure includes sections (also referred to as steps), each of which is represented, for instance, as S1. Further, each section can be divided into several sub-sections while several sections can be combined into a single section. Furthermore, each of thus configured sections can be also referred to as a circuit, device, module, or means.

Each or any combination of sections explained in the above can be achieved as (i) a software section in combination with a hardware unit (e.g., computer) or (ii) a hardware section, including or not including a function of a related apparatus; furthermore, the hardware section (e.g., integrated circuit, hard-wired logic circuit) may be constructed inside of a microcomputer.

The following will describe advantages provided by the foregoing embodiment of the present disclosure.

As described above, in the information notification system 1 according to the present embodiment, the strength and the mode of the tactile notification are set based on the table shown in FIG. 8A or FIG. 8B corresponding to the age and gender of the driver and the ON or OFF state of the audio device 31. Herein, the age and gender of the driver and the ON or OFF state of the audio device 31 are the factors that may affect a perceivability of the driver to the tactile notification. Thus, with the information notification system according to the present embodiment, information can be notified to the driver in a tactile manner with an improved suitability to the specific driver. Generally, a difficulty in perceiving or sensing the tactile stimulus increases with an increase of an age of a person. Thus, the vibration strength is set to be increased with an increase of the age of the driver. In this case, the driver may be classified into young age, middle age or old age based on a preliminarily set age thresholds. The age threshold may also be set by a user of the information notification system 1. Generally, when the audio device 31 is in the ON state, the attention of the driver is more likely to be distracted by the audio and may not perceive the tactile stimulus in the hand. Thus, when the audio device 31 is in the ON state (FIG. 8B), the strength of the vibration notification is set to be stronger than the strength of the vibration notification under the OFF state of the audio device (FIG. 8A). Further, in the present embodiment, it is assumed that women need more drive assist than men. Thus, the strength of the vibration for the women is set stronger than the strength of the vibration for the men when a man and a woman have the same age.

In the present embodiment, the tactile information output device 10 is connected to the in-vehicle LAN 21 via the HMI controller 20. Thus, when the driver newly purchases the mobile terminal 90, the driver is able to equip the tactile information output device 10 to the vehicle with ease.

As described above, the passenger sensor is connected to the in-vehicle LAN 21. Thus, when the vehicle information acquirement unit 130 acquires the number of the passengers in the compartment of the vehicle as the vehicle information, the parameters related to the tactile notification shown in FIG. 8A and FIG. 8B may be set with consideration of the number of the passengers. Generally, an attention of the driver is more easily distracted with an increase of the number of the passengers in the vehicle and may not perceive the tactile stimulus in the hand. In this case, the parameters of the tactile notification may be set with consideration of the number of the passengers in the vehicle. In the table shown in FIG. 8A, the tactile notification is not performed to the driver who is classified as young men. In this case, the driver may be notified of the information by displaying the information on the display screen of the vehicle or outputting the information from the audio device 31.

In the present embodiment, the mobile terminal 90 functions as a transmitting device. The steering wheel 3 including the tactile information output device 10 functions as a receiving device. The wireless communication module 96 and the drive assist processing unit 150 function as an assist information acquirement section. The vibrators 11 function as a notification section. The driver information acquirement unit 120 and the vehicle information acquirement unit 130 function as a driver related information acquirement section, and the driver information acquired by the driver information acquirement unit 120 together with the vehicle information acquired by the vehicle information acquirement unit are also referred to as driver related information. The assist information generation section 15 functions as a parameter setting section. The camera 95 functions as an image taking device.

In the present embodiment, the assist information may include at least one of route guidance information that guides the vehicle to travel along a predetermined route, lane deviation information that indicates a possibility of a lane deviation of the vehicle, collision danger information that indicates a possibility of a collision of the vehicle with a different object, or external information that is acquired from an external device via a vehicle-to-vehicle communication or via a vehicle-to-roadside communication.

In the present embodiment, the transmitting device is provided by the mobile terminal 90 that is carried into a compartment of the vehicle by the driver.

In the present embodiment, the mobile terminal includes the camera 95 as the image taking device, and the camera takes an image of the face of the driver or takes an image of descriptive information related to an age and a gender of the driver. For example, the camera takes an image of the driving license of the driver. Further, the driver related information acquirement section 120, 130 acquires the driver related information based on the image taken by the camera 95.

### Other Embodiments

In the foregoing embodiment, the ON or OFF state of the audio device 31 is used as the vehicle information. As another example, ON or OFF state of the wipers or ON or OFF state of the headlight may be used as the vehicle information. That is, under a poor visibility, such as during a rain or during a nighttime, the driver needs more drive assist. Thus, the parameters related to the tactile notification shown in the table of FIG. 8A or FIG. 8B may be set corresponding to the poor visibility.

In the foregoing embodiments, the tables shown in FIG. 8A and FIG. 8B are stored in the assist information generation section 15 of the tactile information output device 10. Further, the mobile terminal 90 may store the tables shown in FIG. 8A and FIG. 8B. In this case, the mobile terminal 90 may directly transmit the ON or OFF state, the strength, and the mode of the tactile notification for generating the vibration to the tactile notification section 14 via the in-vehicle LAN 21.

The age and gender of the driver may be acquired based on an image taken by an in-vehicle camera, or may be directly inputted by the driver on a touch panel that is capable of receiving information inputted by the driver. When an image taken by the camera 95 of the mobile terminal 90 is used for specifying the age and gender of the driver, the driver may take the image of himself or herself before boarding the vehicle and carries the mobile terminal 90 with himself or herself into the vehicle. With this configuration, the driver information can be acquired with ease.

In some countries, the driver information is stored in an integrated circuit (IC) chip that is embedded in the driving license. In this case, the driver information can be read from the IC chip of the driving license.

The driver information may further include other private information, such as address of the residence, instead of the age and the gender. When the driver information includes only the address of the residence, the tactile notification may be performed corresponding to the residence address of the driver. For example, when the driver lives in an area having a heavy traffic and complicated road structures, the tactile notification is performed in a different way compared with a case in which the driver lives in a suburban area having less traffic and simple road structures.

The tactile information output device 10 may include a driver identification unit and a vehicle information detection unit. The driver identification unit acquires the driver information that includes the age and gender of the driver from the driver related information received by the communication section 18. The vehicle information detection unit detects and acquires the vehicle information from the driver related information received by the communication section 18. In this case, the assist information generation section 15 may instruct the strength and the mode of the tactile notification based on the driver information acquired by the driver identification unit and the vehicle information acquired by the vehicle information detection unit.

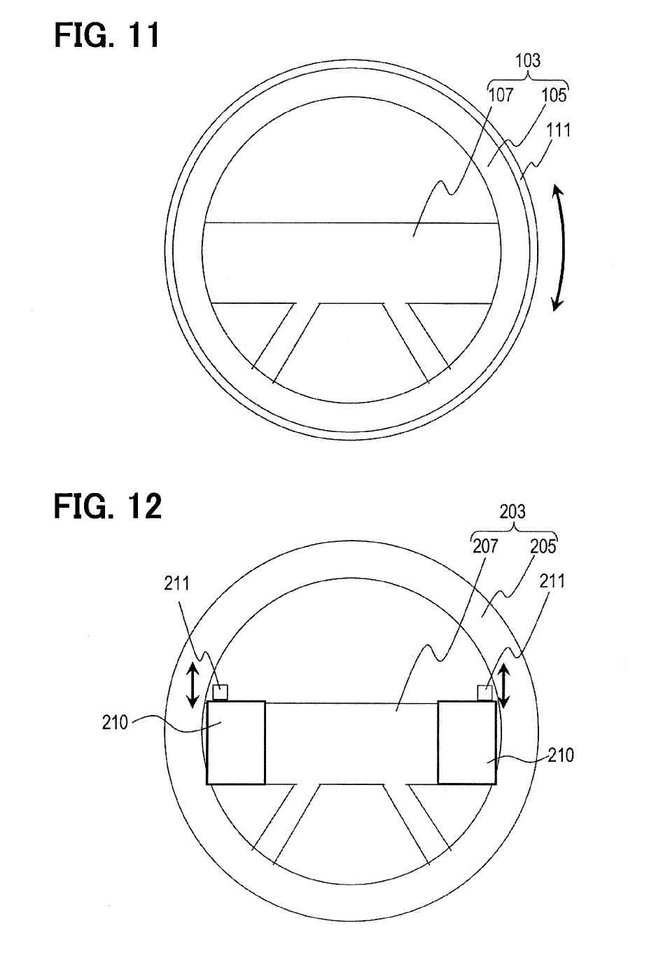

In the foregoing embodiments, the notification section includes the first actuator 12 and the second actuator 13. Each of the first actuator 12 and the second actuator 13 includes multiple vibrators 11. As another example, as shown in FIG. 11, a ring member 111 may be disposed on an outer periphery of a wheel portion 105 of a steering wheel 103. Herein, the steering wheel 103 is supported by a spoke portion 107, and the ring member 111 is rotatable relative to the wheel portion 105 with a rotation axis of the steering wheel 103 as a rotation axis in a circumferential direction as shown by an arrow in FIG. 11. In this configuration, the ring member 111 functions as a tactile notification actuator. Thus, the information is notified to the driver with certainty regardless of which part of the wheel portion 105 is gripped by the driver.

As another example, as shown in FIG. 12, a steering 203 may have a wheel portion 205, a spoke portion 207 that supports the wheel portion 205, and a tactile notification actuator 210 equipped to a connection portion between the wheel portion 205 and the spoke portion 207. The actuator 210 includes a movable part 211 that is able to project from the actuator 210. The movable part 211 is movable in an up-down direction along a plane on which the steering wheel 205 is disposed with respect to the driver as shown by arrows in FIG. 12, and a projected length of the movable part 211 from the actuator 210 is changeable. In the example shown in FIG. 12, two actuators 210, which are paired, are disposed on left and right side of the wheel portion 205, respectively. Two movable parts 211 of the two actuators 210 are disposed corresponding to left thumb and right thumb of the driver, respectively. For example, a widely known stepping motor may be used in the actuator 210. Generally, peripheral nerves of a person are concentrated at an end of the thumb. In this example, since the movable parts 211 of the actuators 210 transfer the vibration to the end of the thumb of the driver, the vibration is notified to the driver with certainty.

In the foregoing embodiments, the notification section is provided by the vibrators 11, the ring member 111, or the movable part 211 that notify the tactile information to the driver. Further, the notification section may be used for other functions, such as warning the driver when the driver is driving in the drowsy state. The notification section may be equipped to a different position other than the steering wheel. For example, the notification section may be equipped to a seat of the driver, or to an armrest of the driver seat of the vehicle under a condition that the driver can perceive the tactile stimulus transferred from the notification section. As described above, when the notification section is equipped to the steering wheel, the driver seat, or the driver armrest, the driver may easily perceive the tactile stimulus transferred from the notification section.

As described above, the driver related information includes the vehicle information. In this case, the mobile terminal 90 may not be connected to the in-vehicle LAN 21. That is, the mobile terminal 90 has no need to be connected to the in-vehicle devices, such as the audio device 31, via the in-vehicle LAN 21. However, as described above, when the mobile terminal 90 is connected with the in-vehicle LAN 21, the mobile terminal 90 is able to acquire information from the accelerator pedal sensor 27, the steering sensor 28, or the brake pedal sensor 29. Thus, the mobile terminal 90 is able to perform more types of drive assist applications.

The drive assist information may include some publically distributed information, such as the disaster information or the urgency information, which are distributed publically without installing any application to the mobile terminal. The drive assist information is also referred to as assist information.

As the mobile terminal 90, terminals other than the smart phone may be used. For example, a feature phone, a tablet terminal, a notebook computer may also be used as the mobile terminal 90. Further, the in-vehicle navigation device may perform the function similar to the mobile terminal 90 of the present disclosure. When the mobile terminal 90 is provided by the in-vehicle navigation device, the navigation device functions as the transmitting device. In this case, the transmitting device provided by the navigation device may communicate with the receiving device provided by the tactile information output device 10 in a wired manner.

In the foregoing embodiments, a part of the process executed by the mobile terminal 90 may be executed by a vehicle side device. For example, the mobile terminal 90 may transmit the image of the face of the driver and the drive assist information to the vehicle side device. Then, the vehicle side device may perform remaining processes including acquiring the age and gender of the driver.

In the foregoing embodiments, the notification section 11, 111, 211 may be equipped to at least one of the wheel portion 5, 105, 205 of the steering wheel 3, 103, 203 of the vehicle, the driver seat of the vehicle, or the driver armrest of the vehicle.

In the foregoing embodiments, different part of each embodiment may be properly combined with other embodiments without departing from the scope of the disclosure.

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. An information notification system comprising:
a transmitting device including an assist information acquirement section, the assist information acquirement section acquiring an assist information that assists a driver during a driving of a vehicle;
a receiving device including a notification section, the notification section notifying the driver of the assist information in a tactile manner;
a driver related information acquirement section acquiring a driver related information, the driver related information being associated with a perceivability of the driver to the assist information that is notified to the driver in the tactile manner; and
a parameter setting section setting a notification parameter based on the driver related information acquired by the driver related information acquirement section, the notification section notifying the driver of the assist information corresponding to the notification parameter set by the parameter setting section.

2. The information notification system according to claim 1, wherein
the assist information includes at least one of
a route guidance information that guides the vehicle to travel along a predetermined route,
a lane deviation information that indicates a possibility of a lane deviation of the vehicle,
a collision danger information that indicates a possibility of a collision of the vehicle with a different object, or
an external information that is acquired from an external device via a vehicle-to-vehicle communication or via a vehicle-to-roadside communication.

3. The information notification system according to claim 1, wherein
the transmitting device is provided by a mobile terminal that is carried into a compartment of the vehicle by the driver.

4. The information notification system according to claim 3, wherein
the mobile terminal includes an image taking device that takes an image of a face of the driver or takes an image of a descriptive information related to an age and a gender of the driver, and
the driver related information acquirement section acquires the driver related information based on the image taken by the image taking device.

5. The information notification system according to claim 1, wherein
the notification section is equipped to at least one of a wheel portion of a steering wheel of the vehicle, a driver seat of the vehicle, or a driver armrest of the vehicle.

6. The information notification system according to claim 1, wherein
the driver related information acquirement section is included in the transmitting device, and
the parameter setting section is included in the receiving device.

7. A transmitting device performing a communication with a receiving device, the transmitting device comprising:
an assist information acquirement section acquiring an assist information that assists a driver during a driving of a vehicle, the driver being notified of the assist information in a tactile manner; and
a driver related information acquirement section acquiring a driver related information, the driver related information being associated with a perceivability of the driver to the assist information notified to the driver in the tactile manner,
wherein the transmitting device transmits the assist information and the driver related information to the receiving device.

8. A receiving device performing a communication with a transmitting device, the transmitting device transmitting an assist information and a driver related information to the receiving device, the assist information assisting a driver during a driving of a vehicle and the driver related information being associated with a perceivability of the driver to the assist information, the receiving device comprising:
a notification section notifying the driver of the assist information in a tactile manner; and
a parameter setting section setting a notification parameter based on the driver related information, the notification section notifying the driver of the assist information corresponding to the notification parameter set by the parameter setting section.
